(19) United States
(12) Patent Application Publication
(10) Pub. No.: US 2008/0157040 A1
(43) Pub. Date: Jul. 3, 2008

(54) Nail Device and Method

(76) Inventor: Glenn Hironaga, Honolulu, HI (US)

Correspondence Address: ITALIA IP, 3500 WEST OLIVE AVE., SUITE 300, BURBANK, CA, 91505, US

(21) Appl. No.: 11/619,188

(22) Filed: Jan. 2, 2007

(51) Int. Cl. B25C 11/00; B66F 15/00

(52) U.S. Cl. 254/21; 7/166

(57) ABSTRACT

A nail device including an elongated body having a handle at one end of said body and a nailing region for adapting nail elements to on the opposite end, wherein the nailing region comprises a broad surface for receiving the blow of a hammer and means for interchanging the nail elements, wherein the nail elements can be either nail setting elements or center punch elements.

### BACKGROUND OF INVENTION

This application relates generally to carpentry tools. More specifically, this application relates to a nail device and method for setting nails below a nailed surface and/or to provide a center punch.

### SUMMARY

This application discloses a nail device that is economical to produce, of simple construction and capable of mass production, but also capable of providing a user a suitable means to set nails or provide a center punch.

In particular, this application discloses a nail device including an elongated body having a handle at one end of said body and a nailing region for adapting nail elements to on the opposite end, wherein the nailing region comprises a broad surface for receiving the blow of a hammer and means for interchanging the nail elements, wherein the nail elements can be either nail setting elements or center punch elements.

Further, this application discloses a method of setting a nail, the method including using a nail device comprising an elongated body having a handle at one end of said body and a nailing region for adapting nail elements to on the opposite end, wherein the nailing region comprises a broad surface for receiving the blow of a hammer and means for interchanging the nail elements, wherein the nail elements are nail setting elements, selecting the appropriate sized nail setting element, retaining the nail setting element in said nail region, positioning the nail setting element upon the nail, and applying a force to the broad surface of the nail region with the hammer thereby setting the nail.

### BRIEF DESCRIPTION OF THE DRAWINGS

The drawings, when considered in connection with the following description, are presented for the purpose of facilitating an understanding of the subject matter sought to be protected.

FIG. 1 is side plan view of a first embodiment of the nail device;

FIG. 2 is a perspective view of the device in FIG. 1;

FIG. 3 is a side plan view of a second embodiment of the nail device;

FIG. 4 is a perspective view of the device in FIG. 3;

FIG. 5 is an enlarged perspective view of the nailing region of the device in FIG. 1;

FIG. 6 is an enlarged perspective view of the nailing region in FIG. 5 from a slightly different angle;

FIG. 7 is an enlarged perspective view of the nailing region of the device in FIG. 3;

FIG. 8 is an enlarged perspective view of the nailing region in FIG. 7 from a slightly different angle;

FIG. 9 is a perspective view of a third embodiment of the nail device; and,

FIG. 10 is a perspective view of a fourth embodiment of the nail device;

### DETAILED DESCRIPTION

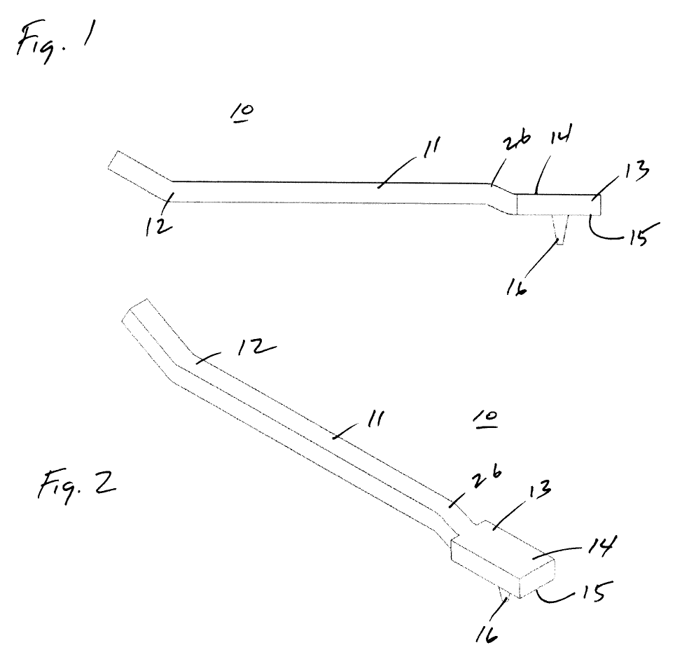

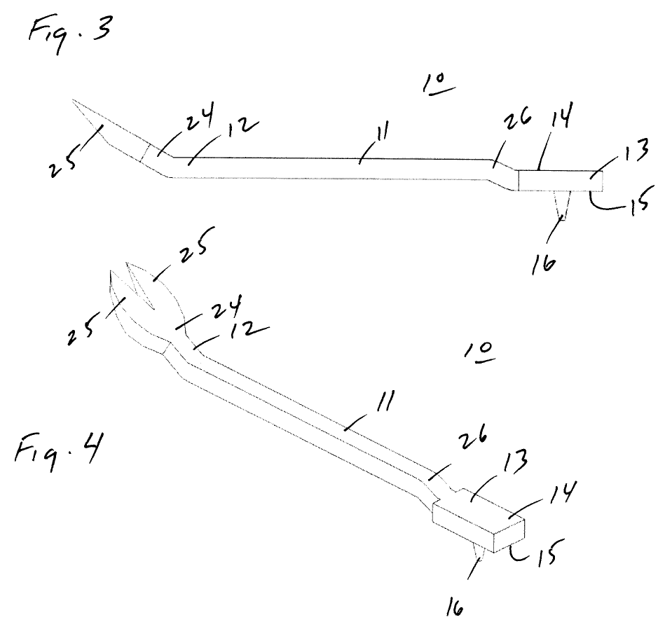

Referring to FIGS. 1-4, shown therein and generally designated by the reference character 10 is the first embodiment of nail device 10 constructed in accordance with the following description. The device 10 comprises an elongated body 11 that is preferably made out of a rigid material such as steel, iron, or any other strong and rigid material that is capable of withstanding the blows of a hammer. The elongated body 11 includes a handle 12 at one end of the body 11 and a nailing region 13 on the opposite end. The handle 12 may be adapted to include a nail prying region 24 wherein the nail prying region includes a pair of tapered flanges 25 that are similarly structured to work in the same was as the nail prying region of a common hammer. See FIGS. 3 and 4. The nailing region 13 includes an upper broad surface 14 that is adapted to receive the blows of a conventional hammer and a lower surface 15 that is adapted to receive a nail element 16. As used herein, a “nail element” may include a nail setting element 17 which is used to counter sink nails below the surface or a center punch element 18 which can be used for a variety of purposes. The nailing region 13 may be offset 26 from the elongated body so that a user can hold the handle 12 with sufficient clearance while hammering on the nailing region 13.

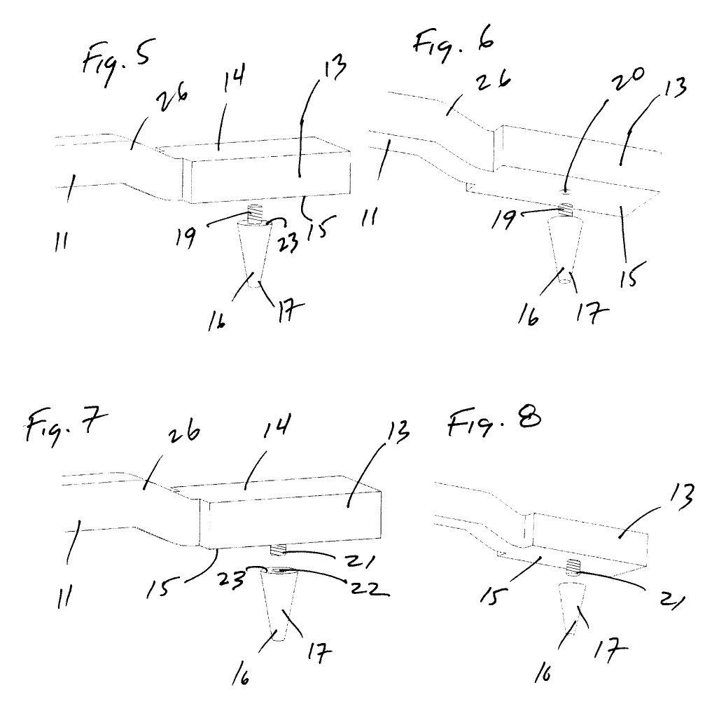

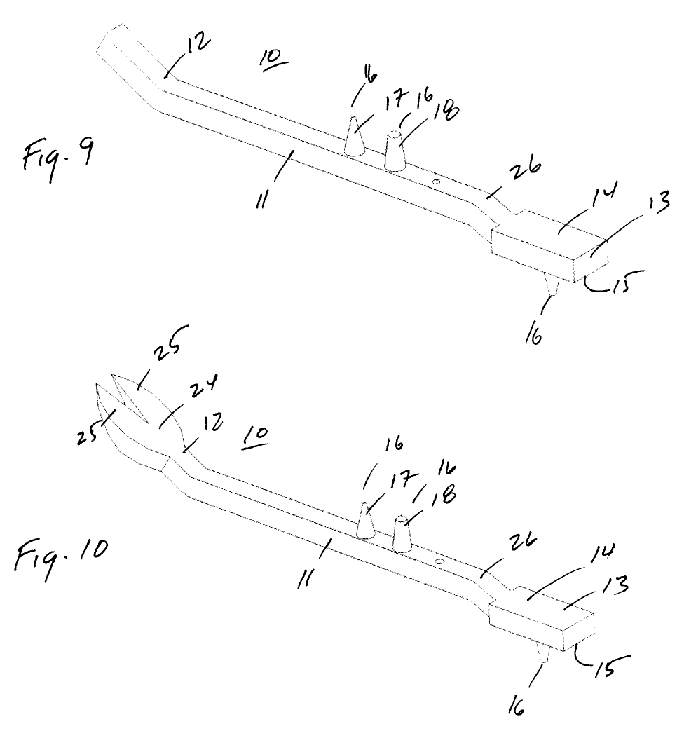

Referring to FIGS. 5-8, the nailing region 13 and nail element 16 include means by which the user can interchange the proper nail element for a given task. For example, when a large headed nail is used a larger nail element 16 is preferred and vice versa. The interchangeable means may include a nail element 16 that includes a threaded male portion 19 that is threadably received by a corresponding threaded bore 20 located on the lower surface 15 of the nailing region 13. See FIGS. 5 and 6. Alternatively, the interchangeable means may include a threaded male portion 21 formed on or welded to the lower surface 15 of the nailing region 13 which may then threadably receive a nail element 16 that includes a corresponding threaded bore 22. With either of the aforementioned interchangeable means, the idea is that the nail element is detachably secured to the nailing region such that when a nail is set or a center is punched, the upper surface 23 of the nail element 16 is braced against the lower surface of the nailing region, so that the force does not strip the threads. Any other means that allow for the interchangeability of the nail elements 16 to the nailing region 13 are contemplated as part of the invention, including but not limited to the quick release mechanisms that are common in the art with respect to drill bits and the like.

Referring to FIGS. 9 and 10, the elongated body 11 of the device 10 may include means for storing nail elements 16 that are not being used. As shown, such storage means may include conventional threaded male and bore structures as described above for the detachable attachment of the interchangeable nail elements 16 to the nailing region 13.

The nail elements 16 may be magnetized so that the nail elements 16 are magnetically attracted to the corresponding nail head which can aid the user in maintaining contact with the nail head when it is being set.

During the operation of the nail device 10 in setting a nail, the following method may be used. First, a user selects the appropriate sized nail element 16, in this case a nail setting element 17, and retains the nail setting element 17 in said nail region 13 as described above. Then the user positions the nail setting element 17 upon the nail to be set and applies a force to the broad surface 14 of the nail region 13 with a hammer thereby setting the nail.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A nail device comprising:
an elongated body having a handle at one end of said body and a nailing region for adapting nail elements to on the opposite end;
wherein said nailing region comprises a broad surface for receiving the blow of a hammer and means for interchanging said nail elements wherein said nail elements are selected from the group consisting of nail setting elements and center punch elements.

2. The nail device of claim 1 wherein said nail elements are magnetized.

3. The nail device of claim 2 wherein said elongated body includes a nail prying region adapted to said handle.

4. The nail device of claim 3 wherein said elongated body includes means for storing said nail elements.

5. The nail device of claim 4 wherein said nailing region is offset from said elongated body.

6. The nail device of claim 1 wherein said elongated body includes a nail prying region adapted to said handle.

7. The nail device of claim 6 wherein said elongated body includes means for storing said nail elements.

8. The nail device of claim 7 wherein said nailing region is offset from said elongated body.

9. The nail device of claim 1 wherein said elongated body includes means for storing said nail elements.

10. The nail device of claim 9 wherein said nail elements are magnetized.

11. The nail device of claim 10 wherein said nailing region is offset from said elongated body.

12. The nail device of claim 1 wherein said nailing region is offset from said elongated body.

13. The nail device of claim 12 wherein said nail elements are magnetized.

14. The nail device of claim 13 wherein said elongated body includes a nail prying region adapted to said handle.

15. A method of setting a nail, the method comprising:
using a nail device comprising an elongated body having a handle at one end of said body and a nailing region for adapting nail elements to on the opposite end, wherein said nailing region comprises a broad surface for receiving the blow of a hammer and means for interchanging said nail elements wherein said nail elements are nail setting elements;
selecting the appropriate sized nail setting element;
retaining said nail setting element in said nail region;
positioning said nail setting element upon said nail; and
applying a force to the broad surface of the nail region with said hammer thereby setting the nail.

16. The method of claim 15 wherein said nail setting elements are magnetized.

17. The method of claim 15 wherein said elongated body includes a nail prying region adapted to said handle.

18. The method of claim 15 wherein said elongated body includes means for storing said nail elements.

19. The method of claim 15 wherein said nailing region is offset from said elongated body.

20. A nail device comprising:
an elongated body having a handle at one end of said body and a nailing region for adapting nail elements to on the opposite end;
wherein said nailing region is offset from said elongated body and comprises a broad surface for receiving the blow of a hammer and means for interchanging said nail elements wherein said nail elements are magnetized and selected from the group consisting of nail setting elements and center punch elements;
wherein said elongated body includes means for storing said nail elements.
